(19) United States
(12) Patent Application Publication
(10) Pub. No.: US 2010/0258364 A1
(43) Pub. Date: Oct. 14, 2010

(54) Excavator

(75) Inventors: Gerhard Bolz, Kirchdorf an der Iller (DE); Alfred Miller, Haslach (DE); Marco Niederer, Blaubeuren (DE)

Correspondence Address: DILWORTH & BARRESE, LLP, 1000 WOODBURY ROAD, SUITE 405, WOODBURY, NY, 11797, US

(73) Assignee: LIEBHERR-HYDRAULIKBAGGER GMBH, Kirchdorf/Iller (DE)

(21) Appl. No.: 12/759,093

(22) Filed: Apr. 13, 2010

(30) Foreign Application Priority Data
Apr. 14, 2009 (DE) UM202009005597.3

(51) Int. Cl. B60K 15/063; B60K 15/03; B60K 15/07; B60K 15/067; B60K 15/073; B60K 15/01; B62D 55/00

(52) U.S. Cl. 180/9.1; 280/834; 180/69.4; 180/314

(57) ABSTRACT

The present invention relates to an excavator having an undercarriage, a superstructure and an internal combustion engine for the drive of the excavator arranged in or at the superstructure, with at least one fuel tank for the supply of the internal combustion engine with fuel being arranged in or/and at the undercarriage of the excavator.

### BACKGROUND OF THE INVENTION

The present invention relates to an excavator having an undercarriage, a superstructure and an internal combustion engine for the drive of the excavator arranged in or at the superstructure.

Excavators usually have an undercarriage and a superstructure, with further assemblies such as an engine, a pump, a radiator and fuel tanks being arranged on the superstructure next to the operator's cabin and the boom. In the present description, mobile excavators and crawler excavators are listed as excavators which are arranged on a corresponding excavator undercarriage. The subject matter of the present invention, however, also relates to crawler cranes and other pieces of working equipment which have a corresponding design with undercarriage and superstructure.

It is common to all these types of equipment that only limited space is available to them on the superstructure due to the maximum transport dimensions. The construction space available on the superstructure must therefore be used to the optimum in order correctly to arrange all assemblies to be accommodated there.

With the known construction types, a large proportion of the space is frequently occupied by the fuel tank at the side of the superstructure.

It has, however, proved problematic in this respect that the assemblies arranged in the central region of the superstructure such as the internal combustion engine, the pump, the radiator or other assemblies can only be accessed with difficulty. This is extremely impractical in particular in the maintenance of the arranged assemblies. The addition of new or further assemblies for the operation of the excavator onto the superstructure of the excavator is furthermore not possible due to the lack of space or can only be realized by dispensing with other assemblies.

### SUMMARY OF THE INVENTION

It is the object of the present invention to further develop an excavator of the known construction such that a space saving is achieved by the repositioning of the assemblies on the superstructure. The regular maintenance of the components to be serviced on the superstructure should furthermore be simplified.

This object is solved in accordance with the invention by the combination of the features herein.

Accordingly, with an excavator having an undercarriage and a superstructure and an internal combustion engine for the drive of the excavator arranged in or at the superstructure, at least one fuel tank for the supply of the internal combustion engine with fuel is arranged in or/and at the undercarriage of the mobile excavator. Since the fuel tank is arranged in the undercarriage, a space saving is produced on the superstructure which can be utilized for other, new components. Furthermore, the accessibility of all the assemblies integrated on the superstructure is facilitated since the relocation of the fuel tank into the undercarriage of the excavator simplifies the spatial arrangement of the individual components. The better refueling possibility with respect to the safety of the operator must be named as a further advantage since the reachability of the fuel tank is considerably improved by the repositioning into the undercarriage. In contrast to excavators in accordance with the prior art, the operator does not have to reach the fuel tank on the elevated superstructure when carrying out the refueling process; the refueling of the excavator is rather comparable with the refueling of a conventional motor vehicle.

At least one fuel container is advantageously arranged outside at the undercarriage of the excavator. In the present description, the term of fuel tank should refer to any desired apparatus for the reception of fuel. The term of the fuel container, in contrast, indicates a container added additionally for the reception of the fuel. This container is not installed as standard at the undercarriage, but is rather actually intended for the exclusive reception of fuel. The accessibility of the fuel tank of the excavator on a refueling procedure is substantially increased by the arrangement of a fuel container for the reception of the fuel outside at the undercarriage. Furthermore, the maintenance of the container is very simple since the container can simply be removed from the superstructure as required. The retrofitting of excavators known from the prior art to an excavator in accordance with the invention having a fuel container arranged at the undercarriage can also be carried out at any time and does not require any new equipping or any huge conversions of the undercarriage. Furthermore, the mobility of the excavator is not restricted or impaired in any way by the repositioning of the fuel tank to the undercarriage of the excavator in the form of a fuel container.

In accordance with a preferred embodiment of the invention, at least one fuel container is at least partly integrated into the undercarriage. The undercarriage of an excavator frequently has unutilized hollow spaces which are at least partly suitable for the reception of a fuel container. A place saving at the undercarriage is likewise produced by the integration of the fuel container into the undercarriage. It is conceivable in this respect that only certain parts of the fuel container are integrated into the undercarriage and the remaining portion of the fuel container is arranged outside at the undercarriage. The complete integration of the fuel container into the hollow spaces of the undercarriage is also possible for a complete space saving.

The at least partial integration of the fuel container into any desired installed parts of the undercarriage is frequently also advantageous. In this respect, these desired installed parts furthermore carry out their original function, but additionally serve for the reception of fuel for the supply of the internal combustion engine of the excavator in accordance with the invention.

In a further preferred embodiment of the invention, the fuel tank is provided as an integrated volume within parts of the undercarriage. In this respect, the fuel quantity for the supply of the internal combustion engine of the excavator is simply filled into the non-utilized hollow spaces of the undercarriage. It is conceivable in this respect that the fuel is filled into restricted sections of the undercarriage. The use of the total volume of the total undercarriage for filling with fuel is likewise feasible. The utilization of the hollow spaces of the desired installed parts of the undercarriage is naturally also conceivable. The installation of an especially made fuel container can be dispensed with by the named embodiment of the invention. The total weight of the excavator can be reduced by the weight of the fuel container by the utilization of existing hollow spaces or volumes of the undercarriage.

The integrated volume within the undercarriage is advantageously sealed from parts of the undercarriage by means of seal welding and can be filled with fuel. The seal welding of the undercarriage provides an unbelievably simple method in the production of the undercarriage to seal the hollow spaces within the undercarriage so that a secure reception of the fuel within the undercarriage is ensured. It is likewise conceivable that only certain parts of the undercarriage are seal welded or specific parts of the undercarriage are separated from the remaining region of the undercarriage by adding separating walls. The volumes of the desired installed parts of the undercarriage can likewise by sealed by seal welding.

To ensure a smooth supply of the internal combustion engine in the superstructure by the fuel tank or fuel container repositioned into the undercarriage, at least one fuel supply line is conducted from the undercarriage to the superstructure and is directly or indirectly connected to the fuel tank/fuel container. This supply line from the fuel tank or fuel container is preferably conducted from the undercarriage to the superstructure within the rotating assembly and is then directly/indirectly connected as standard to the internal combustion engine. It has to be mentioned that the rotary movement of the superstructure about a defined rotary axis about the undercarriage is in no way impaired by the laying of the supply line through the rotating assembly of the excavator.

At least one fuel pump is advantageously arranged in the undercarriage of the excavator and is directly or indirectly connected to the fuel tank or to the fuel container at the inlet side and to the fuel supply line at the outlet side. The fuel filled into the fuel tank or fuel container is pumped by the fuel pump via the fuel supply line through the rotating assembly into the superstructure to the internal combustion engine.

The fuel is advantageously conveyable periodically or cyclically from the fuel tank or fuel container from the undercarriage to the internal combustion engine. The time intervals between the periodic or cyclic fuel flow from the undercarriage into the superstructure are in this respect set in dependence on the operating parameters of the internal combustion engine.

It is also possible that the fuel can be conveyed continuously from the fuel tank or fuel container to the internal combustion engine arranged in the superstructure.

In a further advantageous embodiment of the invention, at least one intermediate fuel tank is arranged in the superstructure. The intermediate fuel tank arranged in the superstructure in this respect satisfies the function of an intermediate fuel buffer, i.e. the fuel conveyed from the fuel tank or fuel container arranged in the undercarriage is intermediately stored in the intermediate fuel tank in the superstructure and is conveyed from there into the internal combustion engine. It is ensured by the intermediate buffering of the fuel in the intermediate fuel tank that a supply of the internal combustion engine with fuel is also provided with a brief interruption of the fuel supply lines from the undercarriage to the superstructure or to the intermediate fuel tank. In this respect, the size ratio between the intermediate fuel tank and the fuel tank or fuel container is highly in favor of the fuel tank or fuel container in the undercarriage. The intermediate fuel tank in this respect only serves for the reception of a minimal fuel quantity since otherwise the space saving achieved in the superstructure is lost.

The fuel can advantageously be conveyed periodically or cyclically from the fuel tank or fuel container in the undercarriage to the intermediate fuel tank in the superstructure. It is naturally also conceivable that the fuel can be conveyed continuously from the fuel tank or fuel container in the undercarriage to the intermediate fuel tank in the superstructure. Care must be taken in both variants that an overflow of the intermediate fuel tank in the superstructure is avoided. The fuel flow from the fuel tank or fuel container in the undercarriage accordingly has to be adapted so that the level in the intermediate fuel tank is kept as constant as possible and a continuous, uninterrupted fuel supply of the internal combustion engine is ensured.

In a particularly advantageous embodiment of the invention, the excavator in accordance with the invention is designed as a crawler excavator and the fuel tank integrated in the undercarriage takes up the volume of the undercarriage between the crawler units. By the repositioning of the fuel tank into the undercarriage of the crawler excavator, a considerable space saving is achieved in the superstructure of the crawler excavator, whereby there is room for the arrangement of further new components in the superstructure of the crawler excavator. The drive of the crawler excavator, i.e. the chain drive of the crawler, is neither restricted nor impeded by the relocation of the fuel tank into the undercarriage.

In another embodiment possibility of the excavator in accordance with the invention, the excavator is designed as a mobile excavator and a respective fuel container is arranged to the side at the undercarriage of the automotive excavator between the front axle and the back axle. The advantages of the repositioning of the fuel tank into the undercarriage of the excavator in accordance with the invention thereby likewise result in this mobile excavator as well as a substantial advantage in the refueling of the mobile excavator.

### BRIEF DESCRIPTION OF THE DRAWINGS

Further features, details and advantages of the invention will be explained in more detail with reference to embodiments shown in the drawings. There are shown:

FIG. 1: a plan view of the undercarriage of a mobile excavator;

FIG. 2: a side view of the undercarriage of the mobile excavator of FIG. 1;

FIG. 3: a plan view of the undercarriage of a crawler excavator;

FIG. 4: a side view of the undercarriage of the mobile excavator of FIG. 3;

FIG. 5: a plan view of a further undercarriage of a further crawler excavator;

FIG. 6: a side view of the undercarriage of FIG. 5;

FIG. 7: a plan view of a third undercarriage of a third crawler excavator; and

FIG. 8: a side view of the undercarriage of FIG. 7.

### DESCRIPTION OF THE PREFERRED EMBODIMENTS

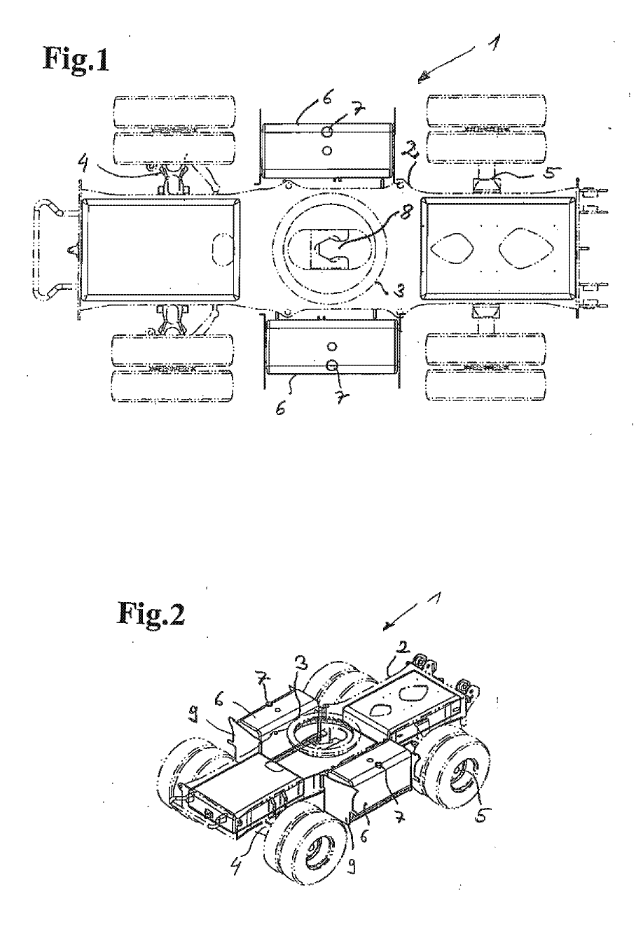

The mobile excavator 1 shown in FIGS. 1 and 2 has an undercarriage 2 and a superstructure, not shown, in the usual manner. The undercarriage 2 has a mobile excavator underbody which provides a front axle 4 and a back axle 5. On the undercarriage 2, the superstructure can be placed on the rotating assembly 3 rotatably about a vertical axis of rotation with respect to the undercarriage 2. The superstructure which is not shown has, in addition to the operator's cabin and the boom, a number of components which comprise the internal combustion engine, pumps, radiators and the like. Counterweights can be arranged in a known manner in the rear region of the superstructure.

In accordance with the invention, two fuel containers 6 have been relocated from the superstructure to the undercarriage 2 and are arranged fixedly thereat in the mobile excavator 1 of FIGS. 1 and 2. In this respect, a respective fuel container 6 is located to the side at the undercarriage 2 between the front axle 4 and the back axle 5 of the undercarriage 2. Two receivers 9 which are fixedly welded to the undercarriage 2 serve for the fixing or fastening of the fuel containers 6 to the undercarriage 2 of the mobile excavator 1. Both fuel containers 6 each have a filler neck 7 which serves for the filling of the fuel container 6 with fuel. The space in the superstructure, not shown, of the mobile excavator 1 which has become free by the relocation of the fuel tank into the undercarriage 2 of the mobile excavator 1 can be utilized by the addition of further, new components for the operation of the mobile excavator. The maintenance of other assemblies arranged in the superstructure is furthermore facilitated since their accessibility was improved by the repositioning of the fuel tank into the undercarriage 2 of the mobile excavator 1.

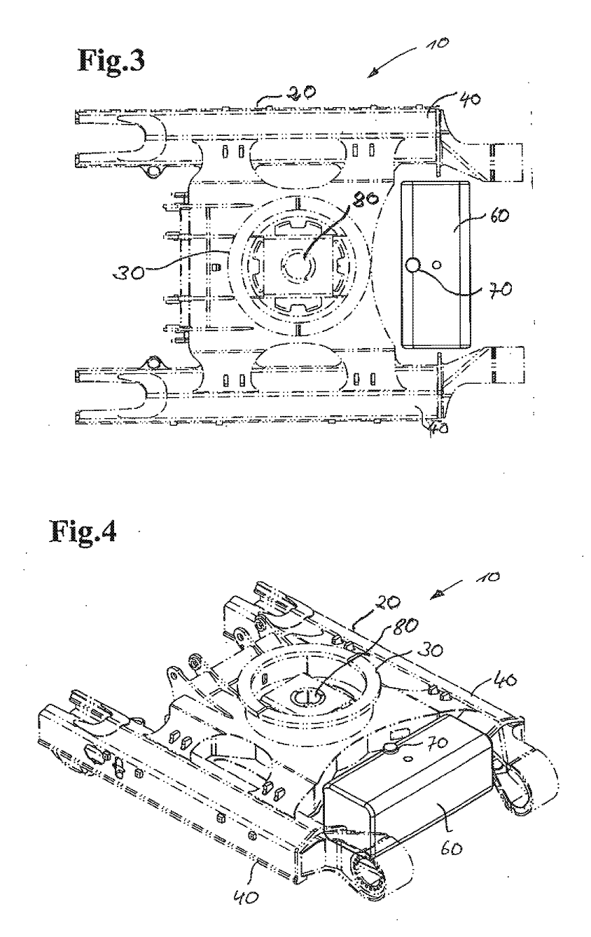

The further FIGS. 3 to 8 illustrate a crawler excavator 10 which likewise, in the usual manner, has an undercarriage 20 and a superstructure, not shown, movably fastened by means of the rotating assembly 30. In this respect, the undercarriage 20 provides a crawler underbody which provides the two crawler units 40 as well as the crawler chain, not shown, and its drive apparatus. The superstructure, not shown, likewise has, in addition to the operator's cabin and the boom, a number of components which comprise engines, pumps, radiators and the like. As with the superstructure of the mobile excavator 1 from FIGS. 1 and 2, counterweights can be arranged in a known manner in the rear region of the superstructure.

In accordance with the invention, the fuel tank is likewise repositioned from the superstructure into the undercarriage 20 in the crawler excavator 10 from FIGS. 3 to 8, whereby a substantial space saving is achieved in the superstructure. The first embodiment possibility of the crawler excavator is shown in FIGS. 3 and 4. In this respect, a fuel container 60 is arranged outside the undercarriage 20 fixed thereto, with the fuel container 60 being arranged fixed to the undercarriage 20 between the crawler units 40 in the rear part of the undercarriage 20. It generally applies that the fuel container can be arranged at any suitable position of the undercarriage. The mobility of the crawler crane 10 is not restricted by such an arrangement of the fuel container 60. The fuel container 60 has a filler neck 70 for the filling of the fuel container 60 with fuel. As can be seen from the two FIGS. 3 and 4, the fuel container 60 is easily accessible for the operator for the refueling of the crawler excavator.

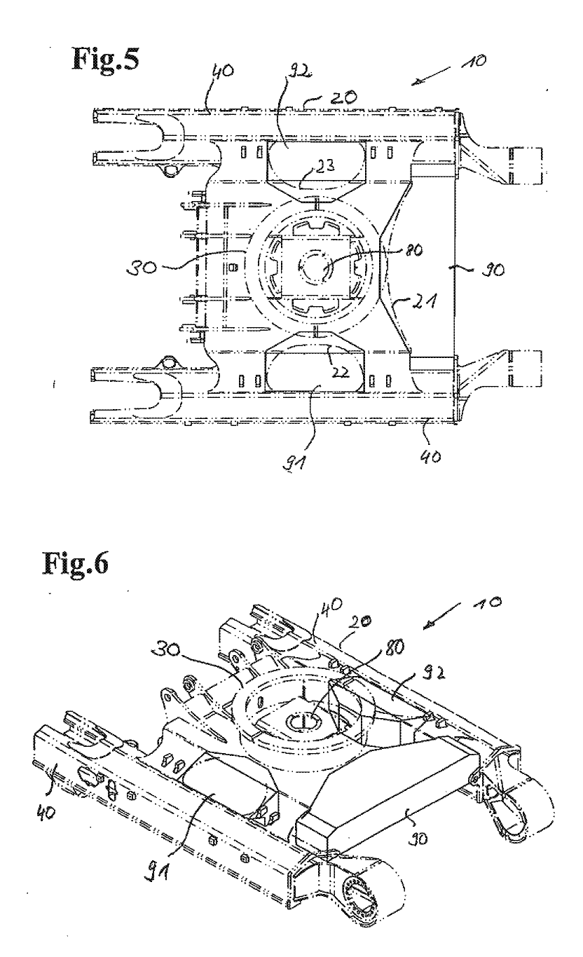

A further embodiment possibility of the crawler excavator in accordance with the invention is shown in FIGS. 5 and 6 which provides an at least partial integration of the fuel container 90 into the undercarriage 20 of the crawler excavator 10. It can clearly be recognized in FIG. 5 that the fuel container 90 additionally includes the two further containers 91 and 92. All three fuel containers 90, 91, 92 are at least partially integrated into the undercarriage 20 of the crawler excavator 10. The dashed lines 21, 22 and 23 from FIG. 5 in this respect indicate the section line of the fuel containers 90, 91, 92 with the undercarriage 20. The part regions of the fuel containers 90, 91, 92, which are disposed on the side of the section lines 21, 22, 23 disposed more closely to the rotating assembly 30, are located within the undercarriage 20, i.e. they are integrated into the undercarriage 20. The individual fuel containers can be connected to one another so that a fuel flow can take place from one fuel container to the next. It is, however, also conceivable that a separate independent supply of the internal combustion engine with fuel is possible from every individual one of the fuel containers.

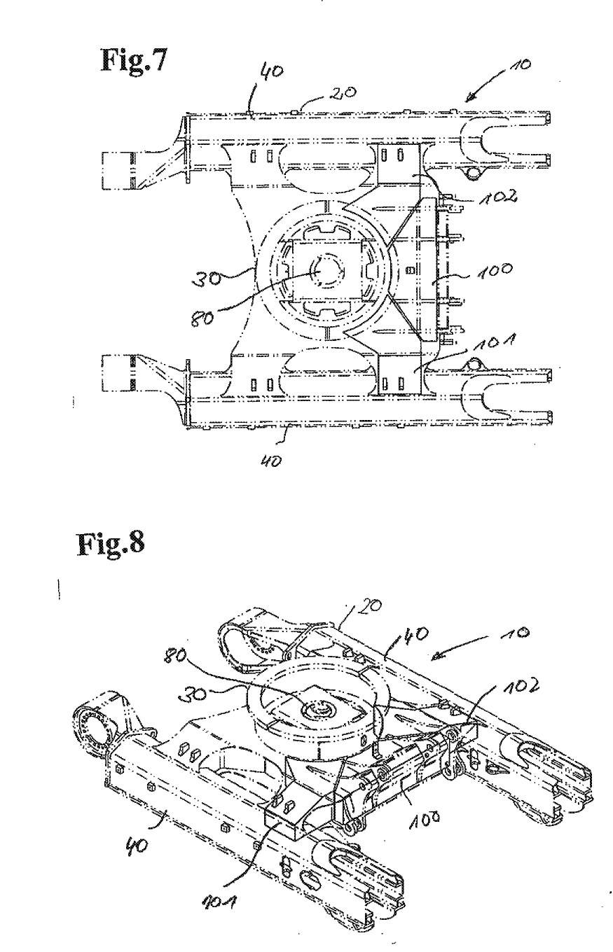

The embodiment variant of the crawler excavator 10 from FIGS. 7 and 8 shows a variant in which the fuel tank 100 is provided as an integrated volume within parts of the undercarriage 20. In this respect, the individual hollow region parts 100, 101, 102 of the undercarriage 20 are sealed by seal welding and can thus be filled with fuel. It also applies here that the individual hollow chambers can be connected to one another or complement one another to form a large hollow space for the reception of fuel or are separated from one another or sealed from one another by means, for example, of inserted dividing walls or in accordance with the starting state of the undercarriage 2. A substantial space saving results by this preferred variant in comparison with the embodiment variant from FIGS. 5 and 6 or FIGS. 3 and 4 by the repositioning of the fuel tank within the undercarriage 20. A huge weight saving can likewise thereby be achieved since the weight of an additionally arranged fuel container 60 or 90, 91, 92 can be saved.

The supply of the internal combustion engine, which is arranged in the superstructure of the mobile excavator 1 or of the crawler excavators 10, can take place by a fuel supply line 8, 80 arranged within the rotating assembly 3, 30. Furthermore, a fuel pump can be arranged in the undercarriage which pumps the fuel, for example cyclically, periodically or continuously, from the fuel container 6, 60, 90, 91, 92 or fuel tank 100, 101, 102 in the undercarriage 2, 20 via the supply lines 8, 80 within the rotating assembly 3, 30 into the superstructure of the mobile excavator 1 or of the crawler excavator 10. The fuel conveyed into the superstructure can be supplied either directly to the internal combustion engine arranged in the superstructure; an intermediate buffering of the fuel conveyed into the superstructure in an intermediate fuel tank which is additionally arranged in the superstructure is likewise conceivable.

1. An excavator having an undercarriage, a superstructure and an internal combustion engine for the drive of the excavator arranged in or at the superstructure, wherein
at least one fuel tank for the supply of the internal combustion engine with fuel is arranged in or/and at the undercarriage of the excavator.

2. An excavator in accordance with claim 1, wherein at least one fuel container is arranged at the outside at the undercarriage of the excavator.

3. An excavator in accordance with claim 1, wherein at least one fuel container is at least partly integrated into the undercarriage.

4. An excavator in accordance with claim 1, wherein at least one fuel container is at least partly integrated into any desired installed parts of the undercarriage.

5. An excavator in accordance with claim 1, wherein at least one fuel tank is provided as an integrated volume within parts of the undercarriage or within the total undercarriage or/and within any desired installed parts of the undercarriage.

6. An excavator in accordance with claim 5, wherein the integrated volume is sealed by means of seal welding from parts of the undercarriage, of the total undercarriage and/or of its installed parts and can be filled with fuel.

7. An excavator in accordance with claim 1, wherein at least one fuel supply line is conducted from the undercarriage of the excavator to the internal combustion engine arranged in the superstructure.

8. An excavator in accordance with claim 1, wherein at least one fuel pump is arranged in the undercarriage and is directly/indirectly connected to the fuel tank/fuel container in the undercarriage.

9. An excavator in accordance with claim 1, wherein the internal combustion engine is arranged in the superstructure and the fuel can be conveyed periodically or cyclically from the fuel tank/fuel container to the internal combustion engine.

10. An excavator in accordance with claim 1, wherein the internal combustion engine is arranged in the superstructure and the fuel can be conveyed continuously from the fuel tank/fuel container to the internal combustion engine.

11. An excavator in accordance with claim 1, wherein at least one intermediate fuel tank is arranged in the superstructure.

12. An excavator in accordance with claim 10, wherein the internal combustion engine is arranged in the superstructure and the fuel can be conveyed periodically or cyclically from the fuel tank/fuel container in the undercarriage to the intermediate fuel tank in the superstructure.

13. An excavator in accordance with claim 10, wherein the internal combustion engine is arranged in the superstructure and the fuel can be conveyed continuously from the fuel tank/fuel container in the undercarriage to the intermediate fuel tank in the superstructure.

14. An excavator in accordance with claim 1, wherein the excavator is designed as a crawler crane and the fuel tank integrated into the undercarriage takes up the volume of the undercarriage between the crawler units and/or at least one fuel container is arranged at the undercarriage between the crawler units.

15. An excavator in accordance with claim 1, wherein the excavator is designed as a mobile excavator and a respective fuel container is arranged between the front axle and the back axle at the side at the undercarriage of the automotive excavator.

16. An excavator in accordance with claim 2, wherein at least one fuel container is at least partly integrated into the undercarriage.

17. An excavator in accordance with claim 16, wherein at least one fuel container is at least partly integrated into any desired installed parts of the undercarriage.

18. An excavator in accordance with claim 3, wherein at least one fuel container is at least partly integrated into any desired installed parts of the undercarriage.

19. An excavator in accordance with claim 2, wherein at least one fuel container is at least partly integrated into any desired installed parts of the undercarriage.

20. An excavator in accordance with claim 17, wherein at least one fuel tank is provided as an integrated volume within parts of the undercarriage or within the total undercarriage or/and within any desired installed parts of the undercarriage.
